(19) United States
(12) Patent Application Publication
(10) Pub. No.: US 2018/0036686 A1
(43) Pub. Date: Feb. 8, 2018

(54) WATER QUALITY MONITORING DEVICE, WATER TREATMENT DEVICE, WATER TREATMENT SYSTEM, WATER QUALITY MONITORING METHOD, AND PROGRAM

(71) Applicant: MITSUBISHI HEAVY INDUSTRIES, LTD., Tokyo (JP)

(72) Inventors: Kiyoshi Tatsuhara, Tokyo (JP); Masayuki Tabata, Tokyo (JP)

(73) Assignee: MITSUBISHI HEAVY INDUSTRIES, LTD., Tokyo (JP)

(21) Appl. No.: 15/551,974

(22) PCT Filed: Feb. 23, 2015
(86) PCT No.: PCT/JP2015/055086

§ 371 Date: Aug. 18, 2017

(51) Int. Cl. B01D 65/08; B01D 61/04; C02F 1/56; B01D 21/32; B01D 21/01; C02F 1/52; B01D 61/02; C02F 1/44

(52) U.S. Cl. CPC B01D 65/08; B01D 61/025; B01D 61/04; C02F 1/441; B01D 21/32; B01D 21/01; C02F 1/5236; C02F 1/56; C02F 2209/01; C02F 2303/16; C02F 2209/006; B01D 2311/246; B01D 2311/2642; C02F 2103/08

(57) ABSTRACT

A water quality monitoring device (111) determines the speed of a wave passing through water present upstream of a reverse osmosis membrane (109). A process for reducing the concentration of organic matter in water present upstream of the reverse osmosis membrane is performed when the determined speed is greater than a predetermined threshold speed.

### TECHNICAL FIELD

The present invention relates to a water quality monitoring device, a water treatment device, a water treatment system, a water quality monitoring method, and a program.

### BACKGROUND ART

Reverse osmosis membranes used in seawater desalination plants are degraded by turbidity components, organic matter, and other fouling substances contained in seawater that is supplied to the reverse osmosis membranes. To prevent degradation of the reverse osmosis membrane, a sand filtration device, a dual media filter (DMF), a ceramic membrane filter (CMF), or other pretreatment device is usually provided upstream of the reverse osmosis membrane. It is also known for a method for preventing degradation of the reverse osmosis membrane, that monitoring the concentration of fouling substances contained in water supplied to the reverse osmosis membrane.

Patent Literature 1 discloses a technique of measuring the viscosity of water supplied to a membrane separation device by a torque meter and stopping the supply of water to the membrane separation device when a value detected by the torque meter is equal to or greater than a predetermined value.

### CITATION LIST

### Patent Literature

[Patent Literature 1]

Japanese Patent No. 3132044

### SUMMARY OF INVENTION

### Technical Problem

Most part of fouling substances contained in seawater is treated by the pretreatment device. Therefore, the amount of fouling substances contained in the water supplied to the reverse osmosis membrane is about several 100 parts per billion (ppb). A change in viscosity due to a change in the concentration of fouling substances at several 100 ppb is from about several tenths of one percent to several percent at most. However, a general torque meter does not have a resolution capable of detecting changes in viscosity of about several tenths of one percent to several percent by online measurement in plant environments.

### Solution to Problem

According to a first aspect of the present invention, a water quality monitoring device which monitors water quality in a water treatment device that generates fresh water using a reverse osmosis membrane includes a speed determination unit which determines a speed of a wave passing through water present upstream of the reverse osmosis membrane to measure a parameter correlated with a concentration of organic matter in the water, and a concentration reduction processing unit which reduces the concentration of organic matter in water present upstream of the reverse osmosis membrane when the speed determined by the speed determination unit is greater than a predetermined threshold speed.

According to a second aspect of the present invention, the water quality monitoring device according to the first aspect further includes a density determination unit which determines a density of water present upstream of the reverse osmosis membrane, wherein, when the speed determined by the speed determination unit is greater than the predetermined threshold speed and the density determined by the density determination unit is less than a predetermined threshold density, the concentration reduction processing unit reduces the concentration of organic matter in water present upstream of the reverse osmosis membrane.

According to a third aspect of the present invention, in the water quality monitoring device according to the first or second aspect, the concentration reduction processing unit reduces the concentration of organic matter in water present upstream of the reverse osmosis membrane using a different method for each range of the speed determined by the speed determination unit.

According to a fourth aspect of the present invention, in the water quality monitoring device according to any one of the first to third aspects, the concentration reduction processing unit reduces the concentration of organic matter in water present upstream of the reverse osmosis membrane by outputting a command to add a flocculant to a chemical injection device which adds a flocculant to water that is supplied to a pretreatment device provided upstream of the reverse osmosis membrane.

According to a fifth aspect of the present invention, in the water quality monitoring device according to any one of the first to fourth aspects, the concentration reduction processing unit reduces the concentration of organic matter in water present upstream of the reverse osmosis membrane by activating a backwash device which backwashes a pretreatment device provided upstream of the reverse osmosis membrane.

According to a sixth aspect of the present invention, the water quality monitoring device according to the second aspect further includes a concentration determination unit which determines a parameter correlated with a concentration of organic matter and a parameter correlated with a concentration of inorganic microparticles on the basis of the speed determined by the speed determination unit and the density determined by the density determination unit, wherein the concentration reduction processing unit reduces the concentration of organic matter in water present upstream of the reverse osmosis membrane when the parameter correlated with the concentration of organic matter determined by the concentration determination unit is greater than the predetermined threshold speed and reduces the concentration of inorganic matter in water present upstream of the reverse osmosis membrane when the parameter correlated with the concentration of inorganic matter determined by the concentration determination unit is greater than the predetermined threshold speed.

According to a seventh aspect of the present invention, a water quality monitoring device which monitors water quality in a water treatment device that generates fresh water using a reverse osmosis membrane includes a speed determination unit which determines a speed of a wave passing through water present upstream of the reverse osmosis membrane to measure a parameter correlated with a concentration of organic matter in the water, and a presentation unit which presents the parameter correlated with the speed determined by the speed determination unit.

According to an eighth aspect of the present invention, the water quality monitoring device according to the seventh aspect further includes a density determination unit which determines a density of water present upstream of the reverse osmosis membrane, wherein the presentation unit presents parameters correlated with the speed and the density.

According to a ninth aspect of the present invention, the water quality monitoring device according to the eighth aspect further includes a concentration determination unit which determines a parameter correlated with a concentration of organic matter and a parameter correlated with a concentration of inorganic microparticles on the basis of the speed determined by the speed determination unit and the density determined by the density determination unit, wherein the presentation unit presents the parameter correlated with the concentration of organic matter and the parameter correlated with the concentration of inorganic microparticles.

According to a tenth aspect of the present invention, the water quality monitoring device according to any one of the first to ninth aspects further includes a storage processing unit which stores part of water present upstream of the reverse osmosis membrane in a predetermined container when the speed determined by the speed determination unit is greater than the predetermined threshold speed.

According to an eleventh aspect of the present invention, in the water quality monitoring device according to any one of the first to tenth aspects, the speed determination unit determines a speed of a wave passing through water before the water passes through a pretreatment device provided upstream of the reverse osmosis membrane and a speed of a wave passing through water after the water passes through the pretreatment device.

According to a twelfth aspect of the present invention, a water treatment device includes a reverse osmosis membrane, a wave transmitter which is provided upstream of the reverse osmosis membrane and which generates a wave in water present upstream of the reverse osmosis membrane, and a wave receiver which is provided upstream of the reverse osmosis membrane and which detects the wave generated by the wave transmitter.

According to a thirteenth aspect of the present invention, the water treatment device according to the twelfth aspect further includes a vibration tube through which water present upstream of the reverse osmosis membrane flows, an oscillator which vibrates the vibration tube, and a vibration detector which detects a vibrational amplitude of the vibration tube, wherein the wave transmitter and the wave receiver are provided on the vibration tube.

According to a fourteenth aspect of the present invention, a water treatment system includes the water treatment device according to the twelfth or thirteenth aspect, and the water quality monitoring device according to any one of the first to eleventh aspects.

According to a fifteenth aspect of the present invention, a water quality monitoring method includes a speed determining step including determining a speed of a wave passing through water present upstream of a reverse osmosis membrane, and a concentration reduction step including reducing a concentration of organic matter in water present upstream of the reverse osmosis membrane when the determined speed is greater than a predetermined threshold speed.

According to a sixteenth aspect of the present invention, a program causes a computer for a water quality monitoring device, which monitors water quality in a water treatment device that generates fresh water using a reverse osmosis membrane, to function as a speed determination unit which determines a speed of a wave passing through water present upstream of the reverse osmosis membrane to measure a parameter correlated with a concentration of organic matter in the water, and a concentration reduction processing unit which reduces the concentration of organic matter in water present upstream of the reverse osmosis membrane when the speed determined by the speed determination unit is greater than a predetermined threshold speed.

According to a seventeenth aspect of the present invention, a program causes a computer for a water quality monitoring device, which monitors water quality in a water treatment device that generates fresh water using a reverse osmosis membrane, to function as a speed determination unit which determines a speed of a wave passing through water present upstream of the reverse osmosis membrane to measure a parameter correlated with a concentration of organic matter in the water, and a presentation unit which presents the parameter correlated with the speed determined by the speed determination unit.

### Advantageous Effects of Invention

According to at least one of the above aspects, the water quality monitoring device measures the speed of a wave generated in water present upstream of the reverse osmosis membrane. The speed of the wave propagating in the water has a correlation with the viscosity of the water. The speed of the wave is determined by a period of time during which the wave propagates. Therefore, since it is possible to improve the temporal resolution, it is possible to improve the detection accuracy of the wave speed. This allows the water quality monitoring device to detect changes in the concentration of fouling substances at several 100 ppb.

### BRIEF DESCRIPTION OF DRAWINGS

FIG. 1 is a schematic diagram showing a configuration of a seawater treatment system according to a first embodiment.

FIG. 2 is a cross-sectional view showing a structure of a measurement device according to the first embodiment.

FIG. 3 is a schematic block diagram showing a configuration of a water quality monitoring device according to the first embodiment.

FIG. 4 is a flowchart showing a sequence of a water quality monitoring process according to the first embodiment.

FIG. 5 is a schematic diagram showing a configuration of a seawater treatment system according to a second embodiment.

FIG. 6 is a flowchart showing a sequence of a water quality monitoring process according to the second embodiment.

FIG. 7 is a schematic diagram showing a configuration of a seawater treatment system according to a third embodiment.

FIG. 8 is a flowchart showing a sequence of a water quality monitoring process according to the third embodiment.

FIG. 9 is a schematic block diagram showing a configuration of a water quality monitoring device according to a fourth embodiment.

FIG. 10 is a flowchart showing a sequence of a water quality monitoring process according to the fourth embodiment.

FIG. 11 is a schematic block diagram showing a configuration of a water quality monitoring device according to a fifth embodiment.

FIG. 12 is a flowchart showing a sequence of a water quality monitoring process according to the fifth embodiment.

FIG. 13 is a schematic diagram showing a configuration of a seawater treatment system according to a sixth embodiment.

FIG. 14 is a schematic block diagram showing a configuration of a water quality monitoring device according to the sixth embodiment.

FIG. 15 is a flowchart showing a sequence of a water quality monitoring process according to the sixth embodiment.

FIG. 16 is a cross-sectional view showing a structure of a measurement device according to a modified example.

FIG. 17 is a schematic block diagram showing a configuration of a computer according to at least one of the embodiments.

### DESCRIPTION OF EMBODIMENTS

### First Embodiment

A first embodiment is described below.

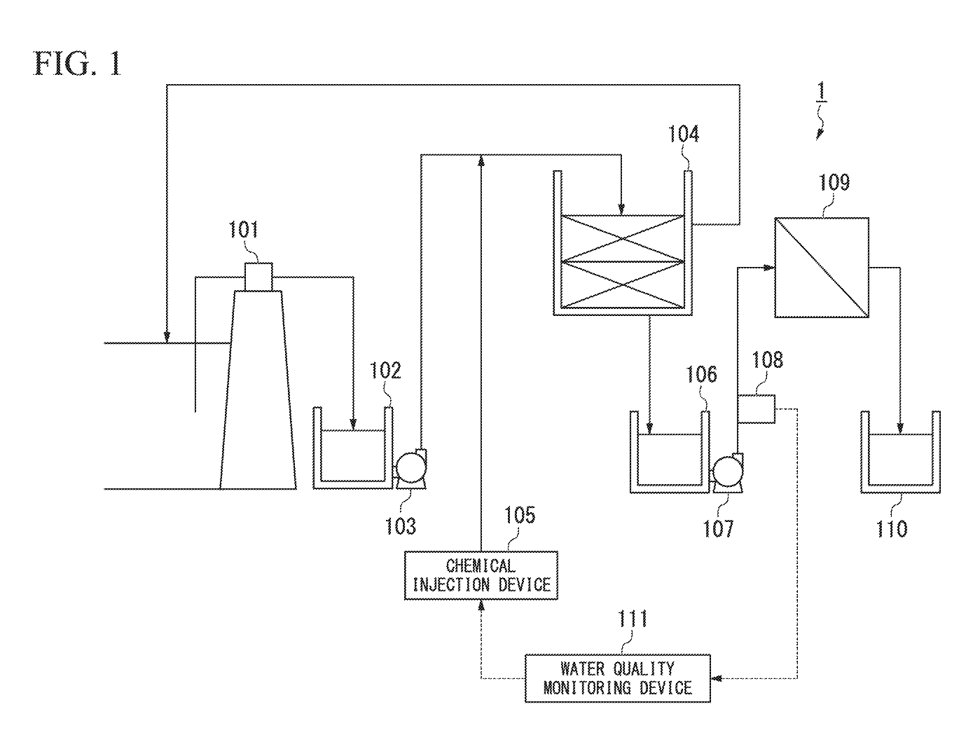

FIG. 1 is a schematic diagram showing a configuration of a seawater treatment system according to the first embodiment. In FIG. 1, solid line arrows represent water distribution pipes and dashed line arrows represent communication lines.

A seawater treatment system 1 is a system for producing fresh water from seawater. The seawater treatment system 1 includes a water intake device 101, a first water storage tank 102, a first pump 103, a DMF 104, a chemical injection device 105, a second water storage tank 106, a second pump 107, a measurement device 108, a reverse osmosis membrane 109, a third water storage tank 110, and a water quality monitoring device 111.

The water intake device 101 takes in seawater from a sea area which is a water intake target. The water intake device 101 allows the taken-in seawater to be stored in the first water storage tank 102.

The first pump 103 delivers seawater stored in the first water storage tank 102 to the DMF 104.

The DMF 104 internally has two types of filtration layers. Examples of the filtration layers include a sand layer and an anthracite layer. The DMF 104 passes seawater delivered by the first pump 103 through the internal filtration layers to filter the seawater. Seawater filtered by the DMF 104 is then stored in the second water storage tank 106.

The chemical injection device 105 adds a flocculant to the seawater delivered by the first pump 103.

The second pump 107 delivers seawater stored in the second water storage tank 106 to the reverse osmosis membrane 109. The second pump 107 operates at a higher pressure than the first pump 103.

The measurement device 108 measures the quality of seawater stored in the second water storage tank 106. The seawater stored in the second water storage tank 106 is water present upstream of the reverse osmosis membrane 109.

The reverse osmosis membrane 109 passes only water molecules of the seawater delivered by the second pump 107. Fresh water obtained by filtration through the reverse osmosis membrane 109 is stored in the third water storage tank 110.

The water quality monitoring device 111 controls the chemical injection device 105 on the basis of the quality of seawater supplied to the reverse osmosis membrane 109.

Although the seawater treatment system 1 according to the present embodiment has a configuration shown in FIG. 1, the present invention is not limited to this and the seawater treatment system 1 may include at least the reverse osmosis membrane 109, the measurement device 108, and the water quality monitoring device 111. For example, a seawater treatment system 1 according to another embodiment may include a sand filtration device, a CMF, or other pretreatment device instead of the DMF 104. A seawater treatment system 1 according to another embodiment may include, for example, a plurality of reverse osmosis membranes 109 connected in parallel or in series. A seawater treatment system 1 according to another embodiment may include another treatment device which reduces the concentration of organic matter in water present upstream of the reverse osmosis membrane 109, instead of the chemical injection device 105. Examples of the treatment device which reduces the concentration of organic matter in water present upstream of the reverse osmosis membrane 109 include a backwash device for the DMF 104 and a pressure control device for the second pump 107. A water treatment system according to another embodiment may generate fresh water from lake water, dam water, or other water instead of seawater.

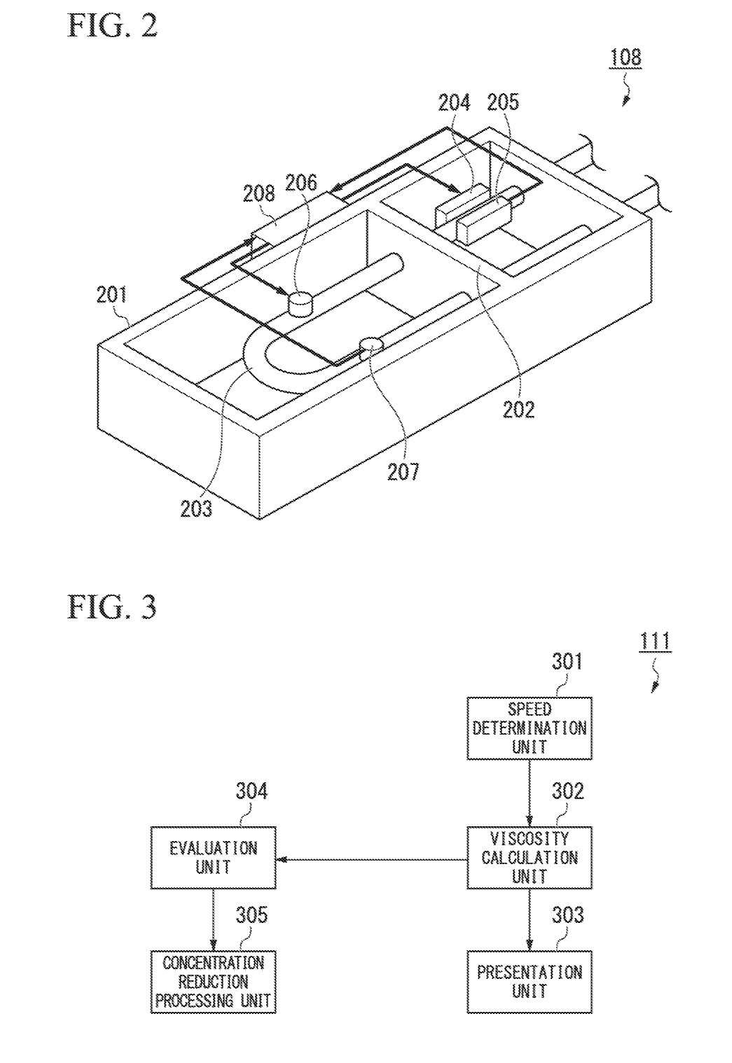

FIG. 2 is a sectional view showing a structure of a measurement device according to the first embodiment.

The measurement device 108 includes a housing 201, a partition plate 202, a U-shaped tube 203, an ultrasonic wave transmitter 204, an ultrasonic wave receiver 205, an oscillator 206, a vibration detector 207, and a calculator 208.

The housing 201 forms an outer shell of the measurement device 108.

The partition plate 202 divides an inner space of the housing 201 into a first compartment and a second compartment.

The U-shaped tube 203 is provided straddling both the first and second compartments of the housing 201. Two ends of the U-shaped tube 203 protrude outward from a wall of the first compartment of the housing 201. That is, the U-shaped tube 203 is provided so as to penetrate the partition plate 202 and the wall of the first compartment of the housing 201. The two ends of the U-shaped tube 203 are attached to a pipe that connects the second pump 107 and the reverse osmosis membrane 109. This structure allows seawater, which is to be supplied to the reverse osmosis membrane 109, to flow into the U-shaped tube 203. The U-shaped tube 203 is fixed to the partition plate 202 and the wall of the first compartment of the housing 201 such that the U-shaped tube 203 does not contact top and bottom surfaces of the housing 201. The U-shaped tube 203 is formed of a highly corrosion-resistant material such as Hastelloy (registered trademark). This can increase the durability of the measurement device 108.

The ultrasonic wave transmitter 204 is fixed to the U-shaped tube 203 in the first compartment of the housing 201. The ultrasonic wave transmitter 204 emits an ultrasonic wave toward the U-shaped tube 203.

The ultrasonic wave receiver 205 is provided opposite the ultrasonic wave transmitter 204, across the U-shaped tube 203. The ultrasonic wave receiver 205 receives the ultrasonic wave generated by the ultrasonic wave transmitter 204 through the U-shaped tube 203.

The oscillator 206 is fixed to the U-shaped tube 203 in the second compartment of the housing 201. The oscillator 206 applies vibrations of a predetermined frequency to the U-shaped tube 203. The oscillator 206 vibrates in a direction perpendicular to a plane defined by the top and the two ends of the U-shaped tube 203.

The vibration detector 207 is fixed to the U-shaped tube 203 in the second compartment of the housing 201. The vibration detector 207 detects a vibrational amplitude of the U-shaped tube 203.

The calculator 208 measures a period of time from when the ultrasonic wave transmitter 204 generates an ultrasonic wave to when the ultrasonic wave receiver 205 receives the ultrasonic wave. The calculator 208 according to the present embodiment measures the period of time with six or more significant figures accuracy. The calculator 208 calculates the sonic speed of the ultrasonic wave on the basis of the period of time from when the ultrasonic wave transmitter 204 generates the ultrasonic wave to when the ultrasonic wave receiver 205 receives the ultrasonic wave. The calculator 208 calculates a resonant frequency of the U-shaped tube 203 on the basis of a relationship between the frequency of vibration by the oscillator 206 and the vibrational amplitude detected by the vibration detector 207. The calculator 208 calculates the density of water filling the U-shaped tube 203 on the basis of the resonant frequency of the U-shaped tube 203.

Although the measurement device 108 according to the present embodiment has a structure shown in FIG. 2, the present invention is not limited to this and the measurement device 108 may include at least a transmitter that generates a wave and a receiver that receives the wave. For example, a measurement device 108 according to another embodiment may not include the oscillator 206 and the vibration detector 207. A measurement device 108 according to another embodiment may include, for example, an ultrasonic wave transmitter 204 and an ultrasonic wave receiver 205 which are directly attached to a pipe which connects a second pump 107 and a reverse osmosis membrane 109. A transmitter according to another embodiment may be configured to generate sound waves, light, or other waves instead of the ultrasonic waves. Although the ultrasonic wave receiver 205 according to the present embodiment is provided opposite the ultrasonic wave transmitter 204, the present invention is not limited to this. For example, an ultrasonic wave receiver 205 according to another embodiment may be provided alongside the ultrasonic wave transmitter 204. In this case, the ultrasonic wave receiver 205 receives the reflection of an ultrasonic wave generated by the ultrasonic wave transmitter 204.

FIG. 3 is a schematic block diagram showing a configuration of a water quality monitoring device according to the first embodiment.

The water quality monitoring device 111 includes a speed determination unit 301, a viscosity calculation unit 302, a presentation unit 303, an evaluation unit 304, and a concentration reduction processing unit 305.

The speed determination unit 301 acquires information indicating the speed of the ultrasonic wave from the measurement device 108.

The viscosity calculation unit 302 calculates the viscosity of water which is supplied to the reverse osmosis membrane 109 on the basis of the information acquired by the speed determination unit 301.

The presentation unit 303 allows a not-shown display device to display the viscosity calculated by the viscosity calculation unit 302. The presentation unit 303 is an example of a process execution unit that performs a process based on the speed of the ultrasonic wave determined by the speed determination unit 301.

The evaluation unit 304 evaluates whether or not the viscosity of water which is supplied to the reverse osmosis membrane 109 is greater than a predetermined threshold viscosity on the basis of the viscosity calculated by the viscosity calculation unit 302. The evaluation unit 304 can detect changes of about several percent in the viscosity. This is because the measurement device 108 measures the period of time from when an ultrasonic wave is transmitted to when the ultrasonic wave is received with six or more significant figure accuracy.

The concentration reduction processing unit 305 outputs a command to add a flocculant to the chemical injection device 105 when the viscosity of water which is supplied to the reverse osmosis membrane 109 is greater than the predetermined threshold viscosity. Output of the command to add a flocculant is an example of a process for reducing the concentration of organic matter in water present upstream of the reverse osmosis membrane 109. A concentration reduction processing unit 305 according to another embodiment may perform other processes for reducing the concentration of organic matter in water present upstream of the reverse osmosis membrane 109. Other processes for reducing the concentration of organic matter in water include a command to increase the amount of a flocculant added, a command to change the type of the flocculant, a command to backwash the reverse osmosis membrane 109, and the like. The concentration reduction processing unit 305 is an example of a process execution unit which performs a process based on the speed of an ultrasonic wave determined by the speed determination unit 301.

It is known that the higher the concentration of fouling substances, the greater the influence upon fouling of the reverse osmosis membrane 109. Even when the types of fouling substances in water are the same, the higher the concentration of fouling substances in water is, the greater the viscosity of water is. It is also known that the greater the molecular mass of fouling substances, the greater the influence upon fouling of the reverse osmosis membrane 109. Even when the concentrations of fouling substances in water are the same, the higher the molecular mass of fouling substances in water, the greater the viscosity of water. That is, the level of viscosity of water corresponds to the level of risk of fouling.

The viscosity of water is an example of a parameter correlated with the concentration of organic matter. Other examples of a parameter correlated with the concentration of organic matter include the speed of an ultrasonic wave, the estimated concentration of organic matter, and the volume fraction of organic matter.

Although the water quality monitoring device 111 according to the present embodiment has a structure shown in FIG. 3, the present invention is not limited to this. For example, a presentation unit 303 according to another embodiment may allow the display device to display the speed of the ultrasonic wave instead of the viscosity. In this case, the water quality monitoring device 111 may not include the viscosity calculation unit 302. A presentation unit 303 according to another embodiment may present information using a different presentation method instead of displaying the information on the display device. Examples of a different presentation method include audio output. A water quality monitoring device 111 according to another embodiment may not include the presentation unit 303. Although the evaluation unit 304 according to the present embodiment evaluates whether or not the viscosity calculated by the viscosity calculation unit 302 is greater than the threshold viscosity, the present invention is not limited to this. For example, an evaluation unit 304 according to another embodiment may evaluate whether or not the speed of an ultrasonic wave determined by the speed determination unit 301 is greater than a predetermined threshold speed. Since the speed of an ultrasonic wave is positively correlated with the viscosity of water, evaluating whether or not the viscosity of water is greater than the threshold viscosity is equivalent to evaluating whether or not the speed of an ultrasonic wave is greater than the threshold speed.

A sequence of a water quality monitoring process according to the present embodiment will now be described.

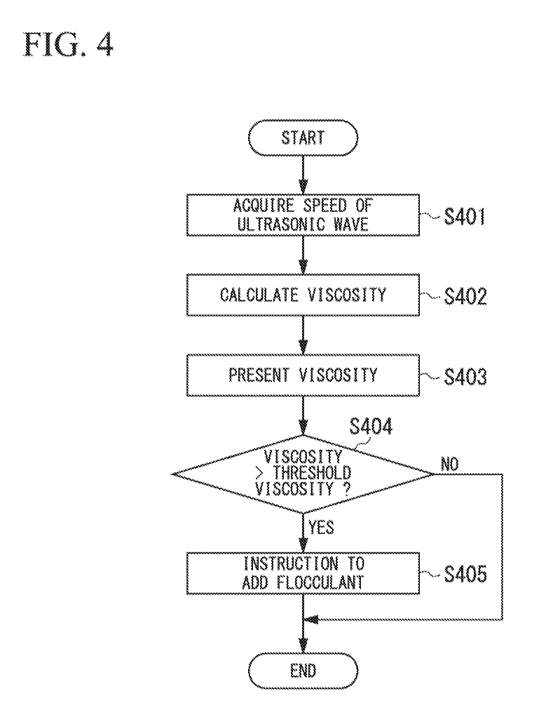

FIG. 4 is a flowchart showing the sequence of the water quality monitoring process according to the first embodiment.

The water quality monitoring device 111 performs the following water quality monitoring process at regular intervals. When the water quality monitoring device 111 starts the water quality monitoring process, the speed determination unit 301 acquires information indicating the speed of an ultrasonic wave from the measurement device 108 (step S401). The viscosity calculation unit 302 then calculates the viscosity of water that is supplied to the reverse osmosis membrane 109 on the basis of the information acquired by the speed determination unit 301 (step S402). A relationship between the speed of an ultrasonic wave and the viscosity of water is previously obtained through experiments or simulation. The presentation unit 303 then allows the display device to display the viscosity calculated by the viscosity calculation unit 302 (step S403).

The evaluation unit 304 evaluates whether or not the viscosity calculated by the viscosity calculation unit 302 is greater than the predetermined threshold viscosity (step S404). The threshold viscosity according to the present embodiment is obtained by multiplying an average viscosity of water that is supplied to the reverse osmosis membrane 109 by a factor of 1 or more (for example, 1.1). The threshold viscosity according to another embodiment may be the viscosity of water which contains organic matter at 100 ppb higher than that of an average quality of water that is supplied to the reverse osmosis membrane 109. In this case, the threshold viscosity can be determined previously by obtaining the viscosity of water obtained by dissolving a water-soluble polymer (for example, polyethylene oxide, xanthan gum, or guar gum) at 100 ppb in water having an average viscosity.

When the viscosity of water is equal to or less than the predetermined threshold viscosity (step S404: NO), the water quality monitoring device 111 terminates the water quality monitoring process and waits until the time of execution of a next water quality monitoring process. On the other hand, when the viscosity of water is greater than the predetermined threshold viscosity (step S404: YES), the concentration reduction processing unit 305 outputs a command to add a flocculant to the chemical injection device 105 (step S405). The water quality monitoring device 111 then terminates the water quality monitoring process and waits until the time of execution of a next water quality monitoring process.

Upon receiving the addition command, the chemical injection device 105 adds a flocculant to water that is supplied to the DMF 104. Adding the flocculant agglomerates organic substances dissolved in water that is supplied to the DMF 104. The concentration of organic substances stored in the second water storage tank 106 is reduced since the agglomerated organic substances are easily filtered out by the DMF 104. This allows the water quality monitoring device 111 to regulate the quality of water that is supplied to the reverse osmosis membrane 109, thereby preventing degradation of the reverse osmosis membrane 109.

As described above, according to the present embodiment, the water quality monitoring device 111 detects changes in the viscosity of water that is supplied to the reverse osmosis membrane 109 at a resolution of about several tenths of one percent to several percent. This is because the measurement device 108 measures the period of time from when an ultrasonic wave is transmitted to when the ultrasonic wave is received with six or more significant figure accuracy. In the calculator 208, improving the resolution of measurement of time is easier than improving the resolution of measurement of rotational torque. Accordingly, by measuring the speed of an ultrasonic wave as in the present embodiment, it is possible to obtain the viscosity of water easily and with a high degree of accuracy.

In addition, according to the present embodiment, the measurement device 108 measures a parameter correlated with the viscosity of water without a moving part being included. This allows the water quality monitoring device 111 to monitor seawater using the measurement device 108 with high durability. Further, according to the present embodiment, the ultrasonic wave transmitter 204 and the ultrasonic wave receiver 205 are provided on an outer wall of the U-shaped tube 203. That is, according to the present embodiment, the water quality monitoring device 111 measures a parameter correlated with the viscosity of water with the ultrasonic wave transmitter 204 and the ultrasonic wave receiver 205 not directly contacting water. This allows the water quality monitoring device 111 to monitor seawater using the measurement device 108 with high durability.

Furthermore, according to the present embodiment, the U-shaped tube 203 of the measurement device 108 serves as a bypass for the pipe that connects the second pump 107 and the reverse osmosis membrane 109. This allows the measurement device 108 to measure the speed of an ultrasonic wave and the density of water without manual sampling of water that is supplied to the reverse osmosis membrane 109. This enables the water quality monitoring device 111 to monitor the viscosity of water that is supplied to the reverse osmosis membrane 109 in an online manner.

### Second Embodiment

A second embodiment is described below.

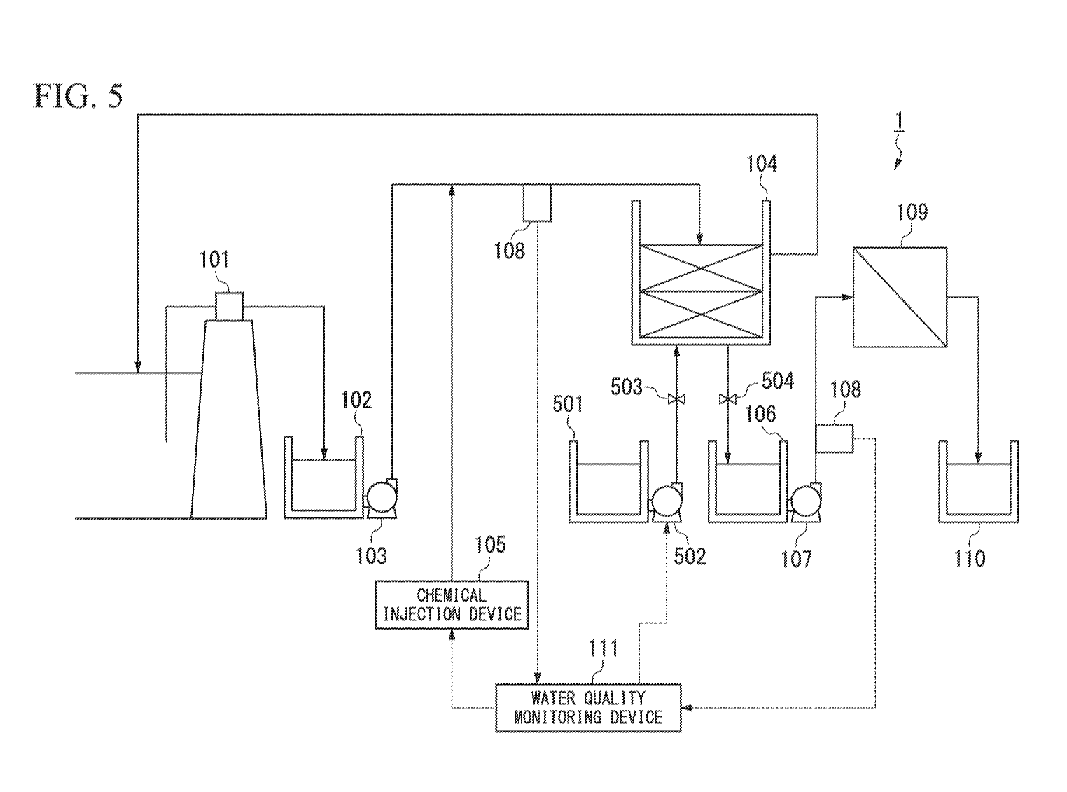

FIG. 5 is a schematic diagram showing a configuration of a seawater treatment system according to the second embodiment.

The water quality monitoring device 111 of the seawater treatment system 1 according to the first embodiment evaluates whether or not it is necessary to add flocculant on the basis of the result of measurement by the measurement device 108. On the other hand, the water quality monitoring device 111 of the seawater treatment system 1 according to the second embodiment evaluates whether or not it is necessary to add a flocculant and whether or not it is necessary to backwash the DMF 104 on the basis of the result of measurement by the measurement device 108.

The seawater treatment system 1 according to the second embodiment includes a backwash water tank 501, a backwash pump 502, a first valve 503, and a second valve 504 in addition to the elements of the first embodiment. In addition, the seawater treatment system 1 according to the second embodiment includes not only the measurement device 108 on the pipe between the second pump 107 and the reverse osmosis membrane 109 but also a measurement device 108 on a pipe between the first pump 103 and the DMF 104.

Concentrated water discharged from the reverse osmosis membrane 109 or seawater is stored in the backwash water tank 501.

The backwash pump 502 backwashes the DMF 104 by delivering water stored in the backwash water tank 501 to the DMF 104 through a water outlet of the DMF 104. Water delivered to the DMF 104 by the back-wash pump 502 is discharged to the sea or effluent treatment facilities.

The first valve 503 is provided between the water outlet of the DMF 104 and a water outlet of the backwash pump 502. The first valve 503 is closed during a normal operation of the seawater treatment system 1 and is opened during backwash treatment.

The second valve 504 is provided between the water outlet of the DMF 104 and a water inlet of the second water storage tank 106. The second valve 504 is opened during a normal operation of the seawater treatment system 1 and is closed during backwash treatment.

A sequence of a water quality monitoring process according to the present embodiment will now be described.

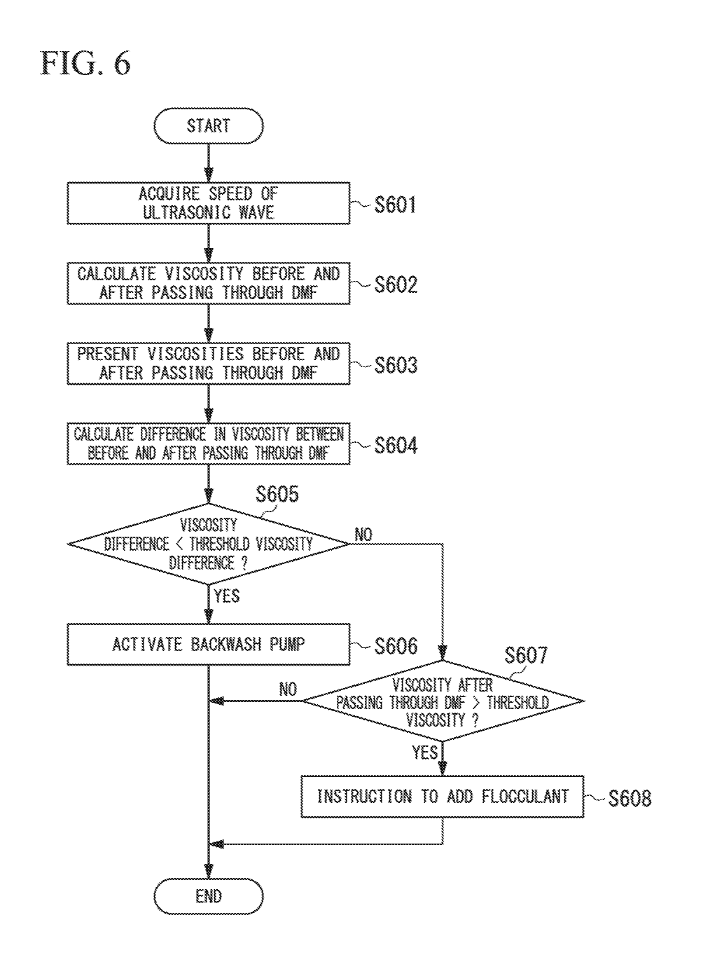

FIG. 6 is a flowchart showing the sequence of the water quality monitoring process according to the second embodiment.

The water quality monitoring device 111 performs the following water quality monitoring process at regular intervals. When the water quality monitoring device 111 starts the water quality monitoring process, the speed determination unit 301 acquires information indicating the speed of an ultrasonic wave from each of the measurement device 108 provided on a pipe between the first pump 103 and the DMF 104 and the measurement device 108 provided on a pipe between the second pump 107 and the reverse osmosis membrane 109 (step S601).

The viscosity calculation unit 302 then calculates the viscosity of water before passing through the DMF 104 and the viscosity of water after passing through the DMF 104 on the basis of the information acquired by the speed determination unit 301 (step S602). Specifically, the viscosity calculation unit 302 calculates the viscosity of water before passing through the DMF 104 on the basis of the speed of an ultrasonic wave measured by the measurement device 108 provided on the pipe between the first pump 103 and the DMF 104. The viscosity calculation unit 302 also calculates the viscosity of water after passing through the DMF 104 on the basis of the speed of an ultrasonic wave measured by the measurement device 108 provided on the pipe between the second pump 107 and the reverse osmosis membrane 109. The presentation unit 303 then allows the display device to display the viscosities calculated by the viscosity calculation unit 302 (step S603).

The evaluation unit 304 calculates the difference between the viscosity of water before passing through the DMF 104 and the viscosity of water after passing through the DMF 104 (step S604). The evaluation unit 304 then evaluates whether or not the calculated viscosity difference is less than a predetermined threshold viscosity difference (step S605). When the difference in viscosity between water before passing through the DMF 104 and water after passing through the DMF 104 is small, this indicates a reduction in the organic matter filtration ability of the DMF 104.

When the viscosity difference is less than the threshold viscosity difference (step S605: YES), the concentration reduction processing unit 305 activates the backwash pump 502 after opening the first valve 503 and closing the second valve 504 (step S606). Backwashing the DMF 104 can restore the organic matter filtration ability of the DMF 104. The concentration reduction processing unit 305 closes the first valve 503 and opens the second valve 504 after activating the backwash pump 502 for a predetermined period of time. The water quality monitoring device 111 then terminates the water quality monitoring process and waits until the time of execution of a next water quality monitoring process. Restoration of the organic matter filtration ability of the DMF 104 reduces the concentration of organic matter in water stored in the second water storage tank 106 during a normal operation after backwashing. This allows the water quality monitoring device 111 to regulate the quality of water that is supplied to the reverse osmosis membrane 109, thereby preventing degradation of the reverse osmosis membrane 109.

On the other hand, when the viscosity difference is equal to or greater than the threshold viscosity difference (step S605: NO), the evaluation unit 304 evaluates whether or not the viscosity of water after passing through the DMF 104 is greater than a predetermined threshold viscosity (step S607). When the viscosity of water after passing through the DMF 104 is equal to or less than the predetermined threshold viscosity (step S607: NO), the water quality monitoring device 111 terminates the water quality monitoring process and waits until the time of execution of a next water quality monitoring process.

On the other hand, when the viscosity of water after passing through the DMF 104 is greater than the predetermined threshold viscosity (step S607: YES), the concentration reduction processing unit 305 outputs a command to add flocculant to the chemical injection device 105 (step S608). The water quality monitoring device 111 then terminates the water quality monitoring process and waits until the time of execution of a next water quality monitoring process.

As described above, according to the present embodiment, the water quality monitoring device 111 detects a reduction in the filtration ability of the DMF 104 on the basis of the difference in viscosity between water before passing through the DMF 104 and water after passing through the DMF 104. This allows the water quality monitoring device 111 to backwash the DMF 104 upon detecting a reduction in the filtration ability of the DMF 104, thereby regulating the filtration ability of the DMF 104. That is, the water quality monitoring device 111 can regulate the quality of water that is supplied to the reverse osmosis membrane 109, thereby preventing degradation of the reverse osmosis membrane 109, not only when the quality of seawater taken in by the water intake device 101 has been reduced but also when the filtration ability of the DMF 104 has been reduced.

### Third Embodiment

A third embodiment is described below.

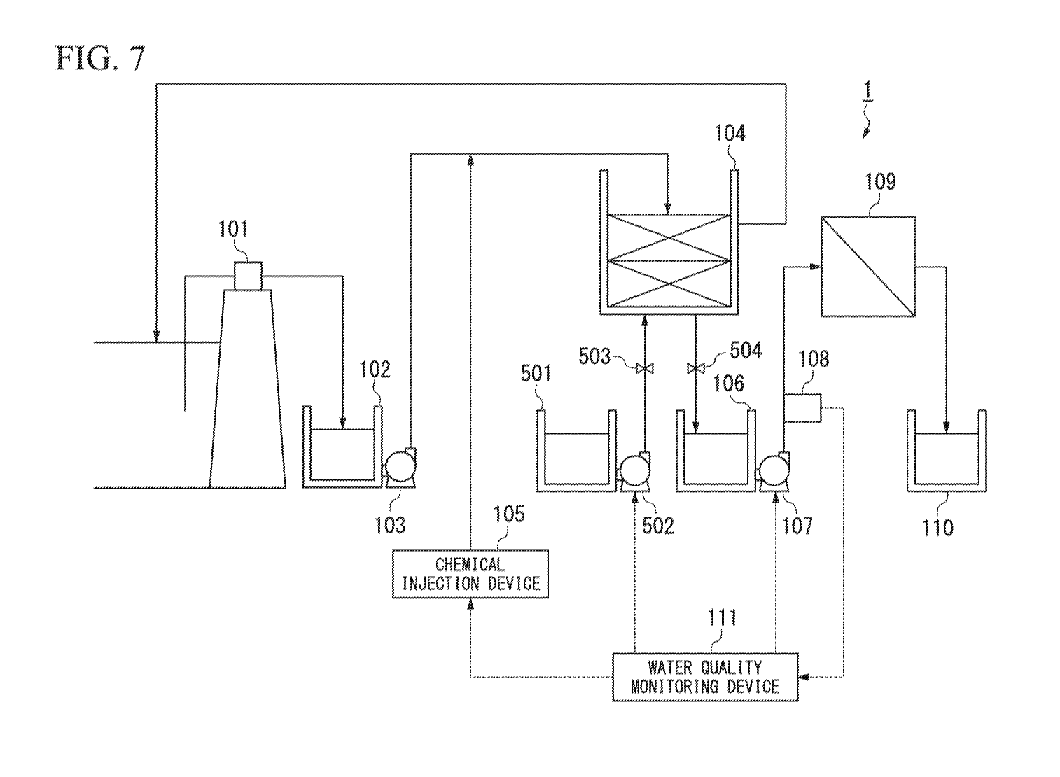

FIG. 7 is a schematic diagram showing a configuration of a seawater treatment system according to the third embodiment.

A water quality monitoring device 111 of a seawater treatment system 1 according to the third embodiment evaluates whether or not it is necessary to add a flocculant, the type of the flocculant added, whether or not it is necessary to backwash the DMF 104, and whether or not it is necessary to stop operation of the seawater treatment system 1 on the basis of the result of measurement by the measurement device 108. Types of the flocculant added by the chemical injection device 105 include an inorganic flocculant and a polymer flocculant. Examples of the inorganic flocculant include ferric chloride. Examples of the polymer flocculant include a cationic polymer flocculant such as a polyacrylate ester compound. The polymer flocculant is used to additionally agglomerate the organic matter agglomerated by the inorganic flocculant.

The seawater treatment system 1 according to the third embodiment does not include the measurement device 108 between the first pump 103 and the DMF 104 among the elements of the second embodiment. That is, the seawater treatment system 1 according to the third embodiment includes the backwash water tank 501, the backwash pump 502, the first valve 503, and the second valve 504 in addition to the elements of the first embodiment.

A sequence of a water quality monitoring process according to the present embodiment will now be described.

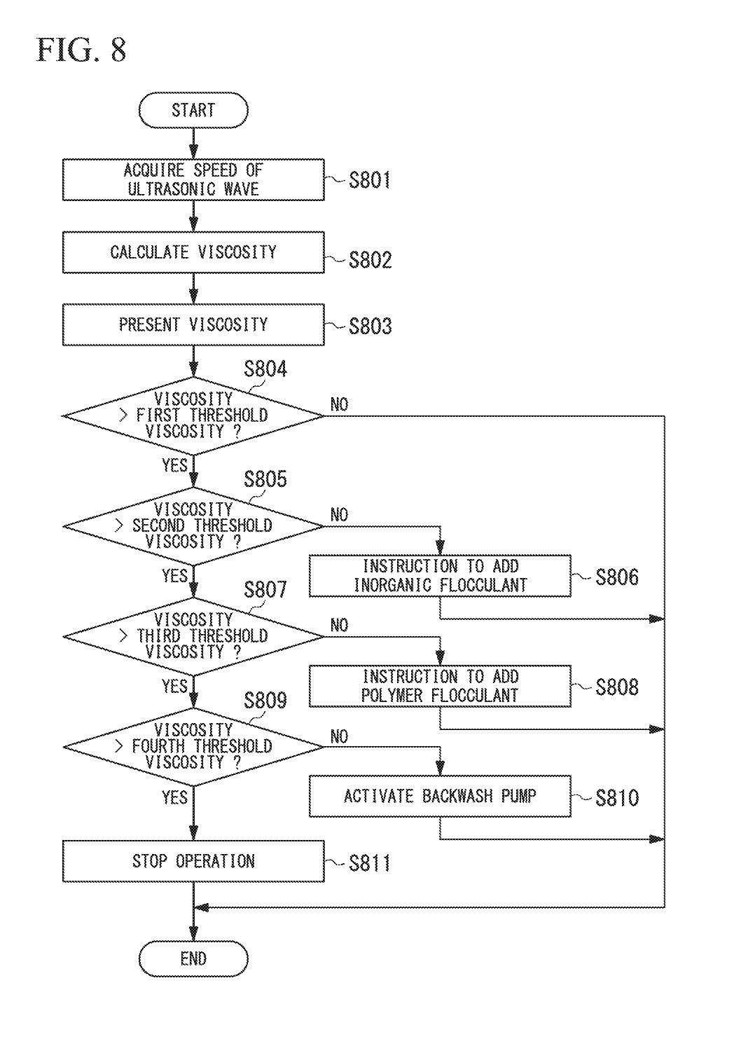

FIG. 8 is a flowchart showing the sequence of the water quality monitoring process according to the third embodiment.

The water quality monitoring device 111 performs the following water quality monitoring process at regular intervals. When the water quality monitoring device 111 starts the water quality monitoring process, the speed determination unit 301 acquires information indicating the speed of an ultrasonic wave from the measurement device 108 (step S801). The viscosity calculation unit 302 then calculates the viscosity of water that is supplied to the reverse osmosis membrane 109 on the basis of the information acquired by the speed determination unit 301 (step S802). The presentation unit 303 then allows the display device to display the viscosity calculated by the viscosity calculation unit 302 (step S803).

The evaluation unit 304 evaluates whether or not the viscosity calculated by the viscosity calculation unit 302 is greater than a first threshold viscosity (step S804). The first threshold viscosity is obtained by multiplying an average viscosity of water that is supplied to the reverse osmosis membrane 109 by a factor of 1 or more (for example, 1.1).

When the viscosity of water is equal to or less than the first threshold viscosity (step S804: NO), the water quality monitoring device 111 terminates the water quality monitoring process and waits until the time of execution of a next water quality monitoring process.

On the other hand, when the viscosity of water is greater than the first threshold viscosity (step S804: YES), the evaluation unit 304 evaluates whether or not the viscosity calculated by the viscosity calculation unit 302 is greater than a second threshold viscosity (step S805). The second threshold viscosity is greater than the first threshold viscosity. The second threshold viscosity is obtained by multiplying an average viscosity of water that is supplied to the reverse osmosis membrane 109 by a factor of 1 or more (for example, 1.2).

When the viscosity of water is equal to or less than the second threshold viscosity (step S805: NO), the concentration reduction processing unit 305 outputs a command to add an inorganic flocculant to the chemical injection device 105 (step S806). Upon receiving the addition command, the chemical injection device 105 adds an inorganic flocculant to water that is supplied to the DMF 104. The water quality monitoring device 111 then terminates the water quality monitoring process and waits until the time of execution of a next water quality monitoring process.

On the other hand, when the viscosity of water is greater than the second threshold viscosity (step S805: YES), the evaluation unit 304 evaluates whether or not the viscosity calculated by the viscosity calculation unit 302 is greater than a third threshold viscosity (step S807). The third threshold viscosity is greater than the second threshold viscosity. The third threshold viscosity is obtained by multiplying an average viscosity of water that is supplied to the reverse osmosis membrane 109 by a factor of 1 or more (for example, 1.3).

When the viscosity of water is equal to or less than the third threshold viscosity (step S807: NO), the concentration reduction processing unit 305 outputs a command to add a polymer flocculant to the chemical injection device 105 (step S808). Upon receiving the addition command, the chemical injection device 105 adds a polymer flocculant to water that is supplied to the DMF 104.

When the viscosity of water is greater than the second threshold viscosity, this indicates that filtration by the DMF 104 is insufficient with only an inorganic flocculant added. Therefore, the water quality monitoring device 111 according to the present embodiment additionally adds a polymer flocculant when the viscosity of water is greater than the second threshold viscosity. This allows organic matter agglomerated by the inorganic flocculant to be additionally agglomerated by the polymer flocculant such that the organic matter is easily filtered out by the DMF 104.

On the other hand, when the viscosity of water is greater than the third threshold viscosity (step S807: YES), the evaluation unit 304 evaluates whether or not the viscosity calculated by the viscosity calculation unit 302 is greater than a fourth threshold viscosity (step S809). The fourth threshold viscosity is greater than the third threshold viscosity. The fourth threshold viscosity is obtained by multiplying an average viscosity of water that is supplied to the reverse osmosis membrane 109 by a factor of 1 or more (for example, 1.5).

When the viscosity of water is equal to or less than the fourth threshold viscosity (step S809: NO), the concentration reduction processing unit 305 activates the backwash pump 502 after opening the first valve 503 and closing the second valve 504 (step S810). The concentration reduction processing unit 305 closes the first valve 503 and opens the second valve 504 after activating the backwash pump 502 for a predetermined period of time. The water quality monitoring device 111 then terminates the water quality monitoring process and waits until the time of execution of a next water quality monitoring process.

When the viscosity of water is greater than the third threshold viscosity, this indicates that filtration by the DMF 104 is insufficient with the flocculants added. That is, when the viscosity of water is greater than the third threshold viscosity, there is a possibility that the filtration ability of the DMF 104 has been reduced. Therefore, the water quality monitoring device 111 according to the present embodiment backwashes the DMF 104 when the viscosity of water is greater than the third threshold viscosity.

On the other hand, when the viscosity of water is greater than the fourth threshold viscosity (step S809: YES), the concentration reduction processing unit 305 stops operation of the second pump 107 (step S811). This allows the concentration reduction processing unit 305 to stop operation of the seawater treatment system 1. The water quality monitoring device 111 then terminates the water quality monitoring process.

When the viscosity of water is greater than the fourth threshold viscosity, this indicates that backwashing cannot restore the filtration ability of the DMF 104. That is, when the viscosity of water is greater than the fourth threshold viscosity, there is a possibility that an abnormality has occurred in the seawater treatment system 1. Therefore, when the viscosity of water is greater than the fourth threshold viscosity, the water quality monitoring device 111 stops operation of the seawater treatment system 1 to prevent contaminated raw water from entering the reverse osmosis membrane 109. Although the water quality monitoring device 111 stops operation of the seawater treatment system 1 when the viscosity of water is greater than the fourth threshold viscosity in the present embodiment, the present invention is not limited to this. For example, in another embodiment, the water quality monitoring device 111 may reduce the amount of water treated by the seawater treatment system 1 instead of stopping operation of the seawater treatment system 1. In this case, the concentration reduction processing unit 305 reduces the pressure of the second pump 107 instead of stopping operation of the second pump 107.

As described above, according to the present embodiment, the water quality monitoring device 111 reduces the concentration of organic matter in water present upstream of the reverse osmosis membrane 109 using a different method for each range of the viscosity of water that is supplied to the reverse osmosis membrane 109. This allows the water quality monitoring device 111 to regulate the quality of water that is supplied to the reverse osmosis membrane 109 using a method suitable for the amount of organic matter included in water, thereby preventing degradation of the reverse osmosis membrane 109.

Although, in the present embodiment, the water quality monitoring device 111 reduces the concentration of organic matter in water present upstream of the reverse osmosis membrane 109 using methods according to four ranges, i.e., a range greater than the first threshold viscosity and equal to or less than the second threshold viscosity, a range greater than the second threshold viscosity and equal to or less than the third threshold viscosity, a range greater than the third threshold viscosity and equal to or less than the fourth threshold viscosity, and a range greater than the fourth threshold viscosity, the present invention is not limited to this. For example, in another embodiment, the water quality monitoring device 111 may reduce the concentration of organic matter in water present upstream of the reverse osmosis membrane 109 using methods according to at least two of the four ranges. In another embodiment, the water quality monitoring device 111 may reduce the concentration of organic matter in water present upstream of the reverse osmosis membrane 109 using methods according to five or more ranges.

### Fourth Embodiment

A fourth embodiment is described below.

The water quality monitoring device 111 of the seawater treatment system 1 according to the first to third embodiments takes measures for reducing the concentration of organic matter when the viscosity of water is high. On the other hand, there is a possibility that inorganic salts, inorganic colloids, and other inorganic microparticles may be suspended in water that is supplied to the reverse osmosis membrane 109. Therefore, when the increase in the viscosity of water is due to the suspension of inorganic microparticles, there is a possibility that the quality of water is not sufficiently improved by measures for reducing the concentration of organic matter.

The water quality monitoring device 111 of the seawater treatment system 1 according to the fourth embodiment determines whether to take measures against an increase in organic matter or to take measures against an increase in the number of inorganic microparticles when the viscosity of water is high.

The configuration of the seawater treatment system 1 according to the fourth embodiment is the same as that of the seawater treatment system 1 according to the first embodiment. The chemical injection device 105 according to the present embodiment adds a flocculant for agglomerating inorganic microparticles in addition to the flocculant for agglomerating organic matter.

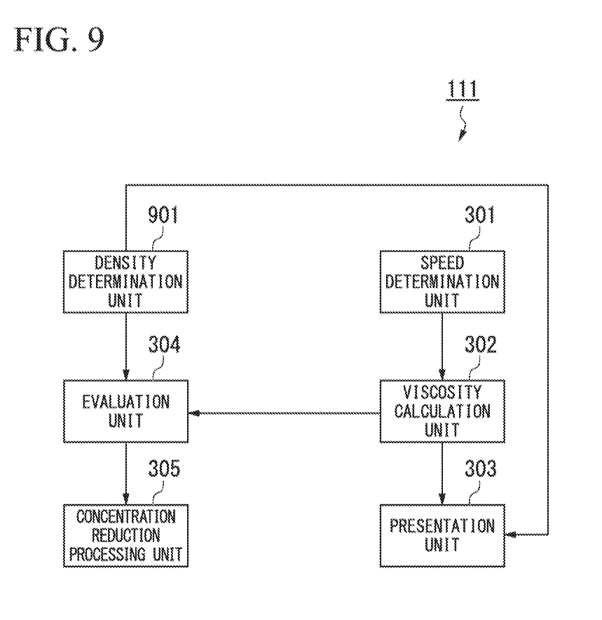

FIG. 9 is a schematic block diagram showing a configuration of a water quality monitoring device according to the fourth embodiment.

The water quality monitoring device 111 according to the fourth embodiment includes a density determination unit 901 in addition to the elements of the first embodiment.

The density determination unit 901 acquires information indicating the density of water from the measurement device 108.

The water quality monitoring device 111 according to the fourth embodiment is different from that of the first embodiment in the operations of the presentation unit 303, the evaluation unit 304, and the concentration reduction processing unit 305.

The presentation unit 303 allows the display device to display the viscosity calculated by the viscosity calculation unit 302 and the density acquired by the density determination unit 901.

The evaluation unit 304 evaluates whether or not it is necessary to add a flocculant on the basis of the viscosity calculated by the viscosity calculation unit 302. The evaluation unit 304 determines the type of a flocculant to be added on the basis of the density acquired by the density determination unit 901.

The concentration reduction processing unit 305 outputs a command to add a flocculant of the type determined by the determination unit to the chemical injection device 105.

A sequence of a water quality monitoring process according to the present embodiment will now be described.

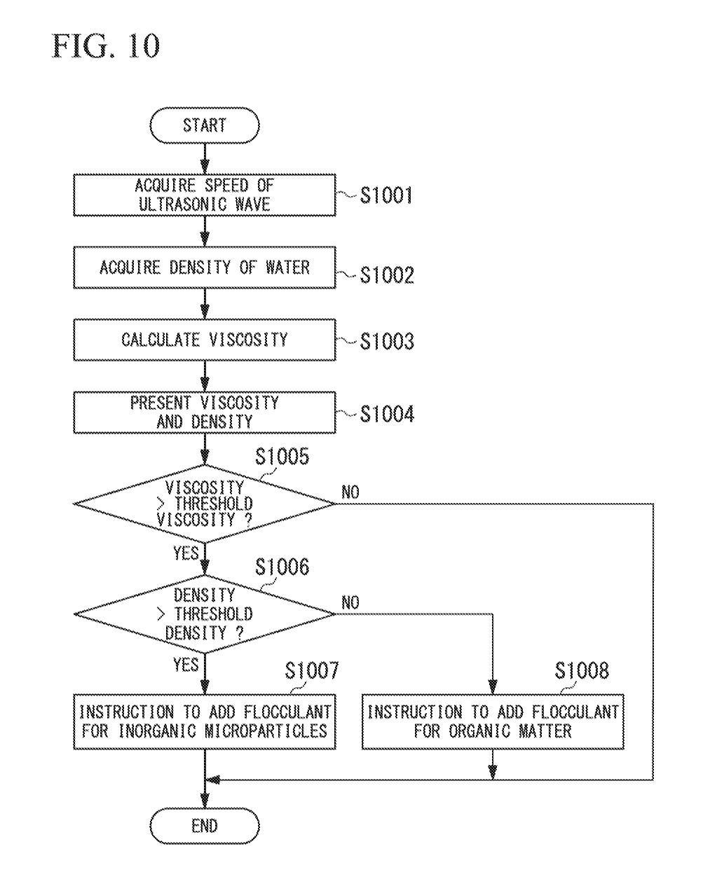

FIG. 10 is a flowchart showing the sequence of the water quality monitoring process according to the fourth embodiment.

The water quality monitoring device 111 performs the following water quality monitoring process at regular intervals. When the water quality monitoring device 111 starts the water quality monitoring process, the speed determination unit 301 acquires information indicating the speed of an ultrasonic wave from the measurement device 108 (step S1001). The density determination unit 901 acquires information indicating the density of water from the measurement device 108 (step S1002). The viscosity calculation unit 302 then calculates the viscosity of water that is supplied to the reverse osmosis membrane 109 on the basis of the information acquired by the speed determination unit 301 (step S1003). The presentation unit 303 then allows the display device to display the viscosity calculated by the viscosity calculation unit 302 and the density acquired by the density determination unit 901 (step S1004).

The evaluation unit 304 evaluates whether or not the viscosity calculated by the viscosity calculation unit 302 is greater than the predetermined threshold viscosity (step S1005). When the viscosity of water is equal to or less than the predetermined threshold viscosity (step S1005: NO), the water quality monitoring device 111 terminates the water quality monitoring process and waits until the time of execution of a next water quality monitoring process. On the other hand, when the viscosity of water is greater than the predetermined threshold viscosity (step S1005: YES), the evaluation unit 304 evaluates whether or not the density acquired by the density determination unit 901 is greater than a predetermined threshold density (step S1006). The threshold density according to the present embodiment is an average density of water that is supplied to the reverse osmosis membrane 109.

The density of inorganic microparticles is greater than the density of water. On the other hand, the density of organic matter is less than the density of water. Therefore, when a large amount of inorganic microparticles are suspended in water that is supplied to the reverse osmosis membrane 109, the density of the water is greater than the average density of water. When a large amount of organic matter is dissolved in water that is supplied to the reverse osmosis membrane 109, the density of the water is equal to or less than the average density of water.

When the density acquired by the density determination unit 901 is greater than the predetermined threshold density (step S1006: YES), the concentration reduction processing unit 305 outputs a command to add a flocculant for agglomerating inorganic microparticles to the chemical injection device 105 (step S1007). On the other hand, when the density acquired by the density determination unit 901 is equal to or less than the predetermined threshold density (step S1006: NO), the concentration reduction processing unit 305 outputs a command to add a flocculant for agglomerating organic matter to the chemical injection device 105 (step S1008).

As described above, the water quality monitoring device 111 according to the present embodiment determines to take measures against an increase of inorganic microparticles when the density of water is greater than the threshold density. In addition, the water quality monitoring device 111 determines to take measures against an increase of organic matter when the density of water is equal to or less than the threshold density. This allows the water quality monitoring device 111 to take appropriate measures against fouling according to the type of matter contained in the water.

In the present embodiment, when the density acquired by the density determination unit 901 is greater than the predetermined threshold density, the chemical injection device 105 adds the flocculant for agglomerating inorganic microparticles, but the present invention is not limited to this. For example, in another embodiment, if it can be determined that the suspension of inorganic microparticles does not significantly affect the fouling of the reverse osmosis membrane 109, the chemical injection device 105 may be configured to add no flocculant when the density acquired by the density determination unit 901 is greater than the predetermined threshold density.

In the present embodiment, the density determination unit 901 acquires information indicating the density calculated based on the resonant frequency from the measurement device 108 having the structure shown in FIG. 2, but the present invention is not limited to this. For example, the measurement device 108 according to another embodiment may calculate the density by measuring the weight of a specific amount of sampled water.

### Fifth Embodiment

A fifth embodiment is described below.

The water quality monitoring device 111 of the seawater treatment system 1 according to the fourth embodiment determines whether to take measures against an increase in organic matter or to take measures against an increase of inorganic microparticles according to the density of water. On the other hand, a water quality monitoring device 111 of a seawater treatment system 1 according to the fifth embodiment determines the proportions of organic matter and inorganic microparticles present in water on the basis of the density of the water and determines whether to take measures against an increase of organic matter or to take measures against an increase of inorganic microparticles.

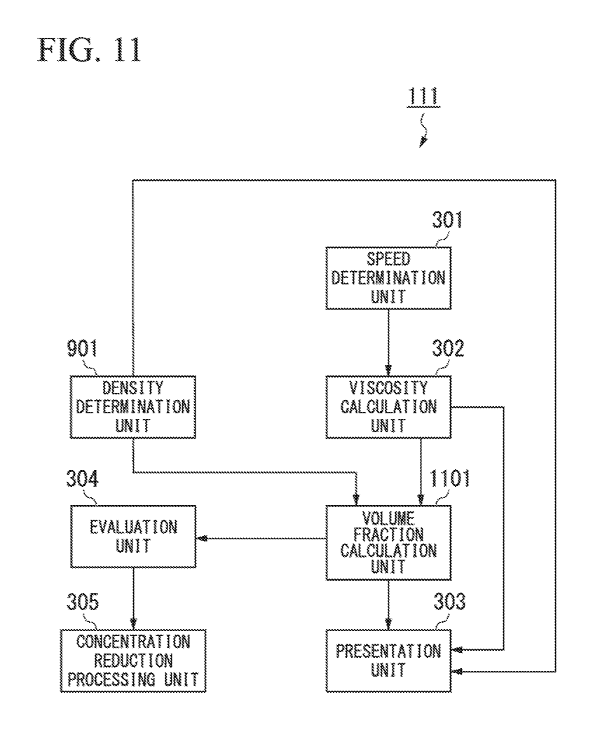

FIG. 11 is a schematic block diagram showing a configuration of the water quality monitoring device according to the fifth embodiment.

The water quality monitoring device 111 according to the fifth embodiment includes a volume fraction calculation unit 1101 in addition to the elements of the fourth embodiment. The volume fraction calculation unit 1101 calculates the volume fractions of organic matter and inorganic microparticles in water on the basis of the viscosity calculated by the viscosity calculation unit 302 and the density determined by the density determination unit 901.

Here, a method of calculating the volume fractions of organic matter and inorganic microparticles in water will be described. The density ρ of water that is supplied to the reverse osmosis membrane 109 is expressed by the following equation (1).

[Math. 1]

ρ=ρ_{SW}(1−φ_{O}−φ_{I})+ρ_{O}φ_{O}+ρ_{I}φ_{I} (1)

ρ_{sw} is the standard density of seawater. ρ_{O} is the density of organic matter. ρ_{I} is the density of inorganic microparticles. φ_{O} is the volume fraction of organic matter. φ_{I} is the volume fraction of inorganic microparticles.

The relative viscosity ηᵣ of water that is supplied to the reverse osmosis membrane 109 is expressed by the following equation (2). The relative viscosity is a value obtained by dividing the viscosity measured by the measurement device 108 by the average viscosity of water that is supplied to the reverse osmosis membrane 109.

[Math. 2]

ηᵣ=1+k_{O}φ_{O}+k_{I}φ_{I} (2)

k_{O} is a coefficient of the viscosity of organic matter. k_{I} is a coefficient of the viscosity of inorganic microparticles.

For example, the coefficient k_{O} of the viscosity of organic substances can be determined previously by dissolving a water-soluble polymer (for example, polyethylene oxide, xanthan gum, or guar gum) in water having an average viscosity while varying the concentration of the water-soluble polymer and obtaining a linear equation indicating the relationship between the volume fraction and the viscosity. The intercept of the linear equation is 1.

For example, the coefficient k_{I} of the viscosity of inorganic microparticles can be determined previously by suspending inorganic microparticles (for example, silica fine particles or calcium carbonate fine particles) in water having an average viscosity while varying the concentration of the inorganic microparticles and obtaining a linear equation indicating the relationship between the volume fraction and the viscosity. The intercept of the linear equation is 1.

From the above equations (1) and (2), the volume fraction φ_{O} of the organic matter and the volume fraction φ_{I} of the inorganic microparticles can be expressed by the following equations (3). The volume fraction calculation unit 1101 calculates the volume fraction φ_{O} of the organic matter and the volume fraction φ_{I} of the inorganic microparticles on the basis of equations (3).

$$\begin{matrix}[ Math . 3 ] & \\ \{ \begin{matrix}{φ}_{O} = \frac{{k}_{I} ( ρ - {ρ}_{SW} ) - ( {η}_{r} - 1 ) ( {ρ}_{I} - {ρ}_{SW} )}{{k}_{I} ( {ρ}_{O} - {ρ}_{SW} ) - {k}_{O} ( {ρ}_{I} - {ρ}_{SW} )} \\ {φ}_{I} = \frac{{k}_{O} ( ρ - {ρ}_{SW} ) - ( {η}_{r} - 1 ) ( {ρ}_{O} - {ρ}_{SW} )}{{k}_{O} ( {ρ}_{I} - {ρ}_{SW} ) - {k}_{I} ( {ρ}_{O} - {ρ}_{SW} )}\end{matrix} & ( 3 )\end{matrix}$$

The water quality monitoring device 111 according to the fifth embodiment is different from that of the fourth embodiment in the operations of the presentation unit 303 and the evaluation unit 304.

The presentation unit 303 allows the display device to display the viscosity calculated by the viscosity calculation unit 302, the density acquired by the density determination unit 901, and the volume fraction calculated by the volume fraction calculation unit 1101.

Based on the volume fraction calculated by the volume fraction calculation unit 1101, the evaluation unit 304 evaluates whether or not it is necessary to add a flocculant used to agglomerate organic matter and a flocculant used to agglomerate inorganic microparticles.

A sequence of a water quality monitoring process according to the present embodiment will now be described.

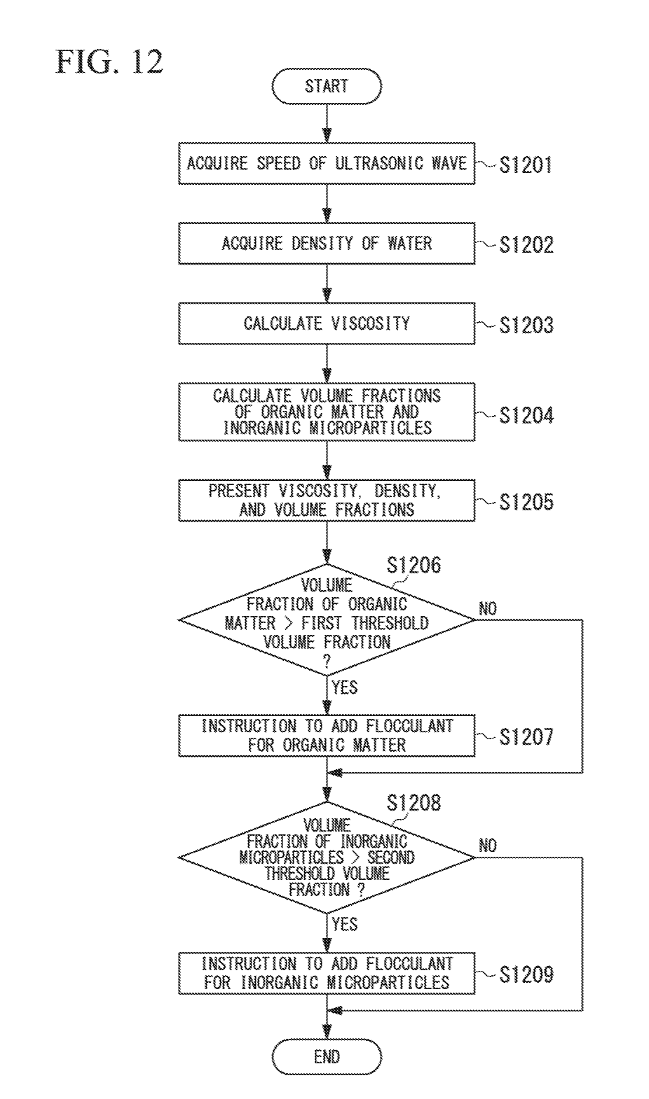

FIG. 12 is a flowchart showing the sequence of the water quality monitoring process according to the fifth embodiment.

The water quality monitoring device 111 performs the following water quality monitoring process at regular intervals. When the water quality monitoring device 111 starts the water quality monitoring process, the speed determination unit 301 acquires information indicating the speed of an ultrasonic wave from the measurement device 108 (step S1201). The density determination unit 901 acquires information indicating the density of water from the measurement device 108 (step S1202). The viscosity calculation unit 302 then calculates the viscosity of water that is supplied to the reverse osmosis membrane 109 on the basis of the information acquired by the speed determination unit 301 (step S1203).

The volume fraction calculation unit 1101 then calculates the volume fractions of organic matter and inorganic microparticles in water on the basis of the viscosity calculated by the viscosity calculation unit 302 and the density determined by the density determination unit 901 (step S1204). The presentation unit 303 then allows the display device to display the viscosity calculated by the viscosity calculation unit 302, the density acquired by the density determination unit 901, and the volume fractions calculated by the volume fraction calculation unit 1101 (step S1205).

The evaluation unit 304 evaluates whether or not the volume fraction of organic matter calculated by the volume fraction calculation unit 1101 is greater than a first threshold volume fraction (step S1206). The first threshold volume fraction according to the present embodiment is a volume fraction corresponding to 100 ppb of organic matter. When the volume fraction of the organic matter is greater than the first threshold volume fraction (step S1206: YES), the concentration reduction processing unit 305 outputs a command to add a flocculant for agglomerating organic matter to the chemical injection device 105 (step S1207).

When the volume fraction of the organic matter is equal to or less than the first threshold volume fraction (step S1206: NO) or when the concentration reduction processing unit 305 has output a command to add a flocculant for agglomerating organic matter, the evaluation unit 304 evaluates whether or not the volume fraction of the inorganic microparticles calculated by the volume fraction calculation unit 1101 is greater than a second threshold volume fraction (step S1208). The second threshold volume fraction according to the present embodiment is a volume fraction of inorganic microparticles corresponding to a silt density index (SDI) 3. When the volume fraction of the inorganic microparticles is greater than the second threshold volume fraction (step S1208: YES), the concentration reduction processing unit 305 outputs a command to add a flocculant for agglomerating inorganic microparticles to the chemical injection device 105 (step S1209).

When the volume fraction of the organic matter is equal to or less than the first threshold volume fraction (step S1208: NO) or when the concentration reduction processing unit 305 has output a command to add a flocculant for agglomerating inorganic microparticles, the water quality monitoring device 111 terminates the water quality monitoring process and waits until the time of execution of a next water quality monitoring process.

As described above, the water quality monitoring device 111 according to the present embodiment determines whether or not to take measures against an increase of organic matter and whether or not to take measures against an increase of inorganic microparticles on the basis of the volume fractions of organic matter and inorganic microparticles. This allows the water quality monitoring device 111 to take appropriate measures against fouling according to the type of matter contained in the water.

### Sixth Embodiment

A sixth embodiment is described below.

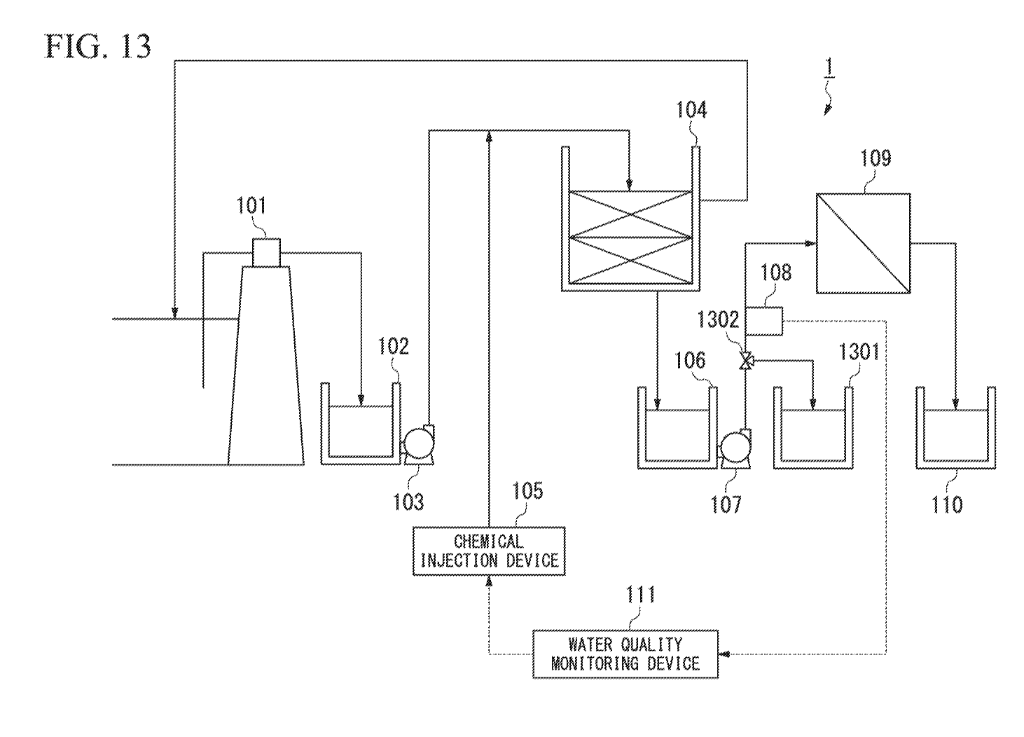

FIG. 13 is a schematic diagram showing a configuration of a seawater treatment system according to the sixth embodiment.

When the quality of water that is supplied to the reverse osmosis membrane 109 has been reduced, a seawater treatment system 1 according to the sixth embodiment samples the water.

The seawater treatment system 1 according to the sixth embodiment includes a sample tank 1301 and a three-way valve 1302 in addition to the elements of the first embodiment.

The three-way valve 1302 is provided at a branch point between a pipe, which connects a pipe connected to the second pump 107 and the reverse osmosis membrane 109, and a pipe connected to the sample tank 1301. The three-way valve 1302 switches the destination of water jumped by the second pump 107 between the reverse osmosis membrane 109 and the sample tank 1301.

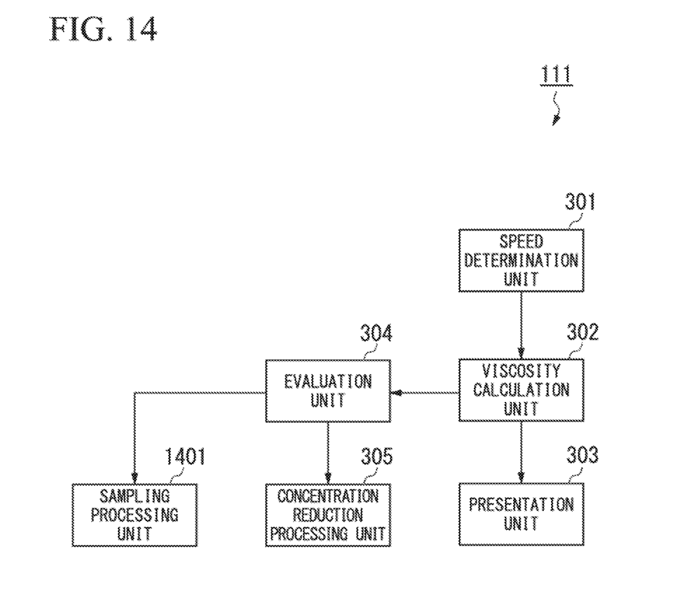

FIG. 14 is a schematic block diagram showing a configuration of a water quality monitoring device according to the sixth embodiment.

A water quality monitoring device 111 according to the sixth embodiment includes a sampling processing unit 1401 in addition to the elements of the first embodiment.

The sampling processing unit 1401 controls the opening and closing of the three-way valve 1302 on the basis of the result of evaluation by the evaluation unit 304. The sampling processing unit 1401 is an example of a process execution unit which performs a process on the basis of the speed of the ultrasonic wave determined by the speed determination unit 301.

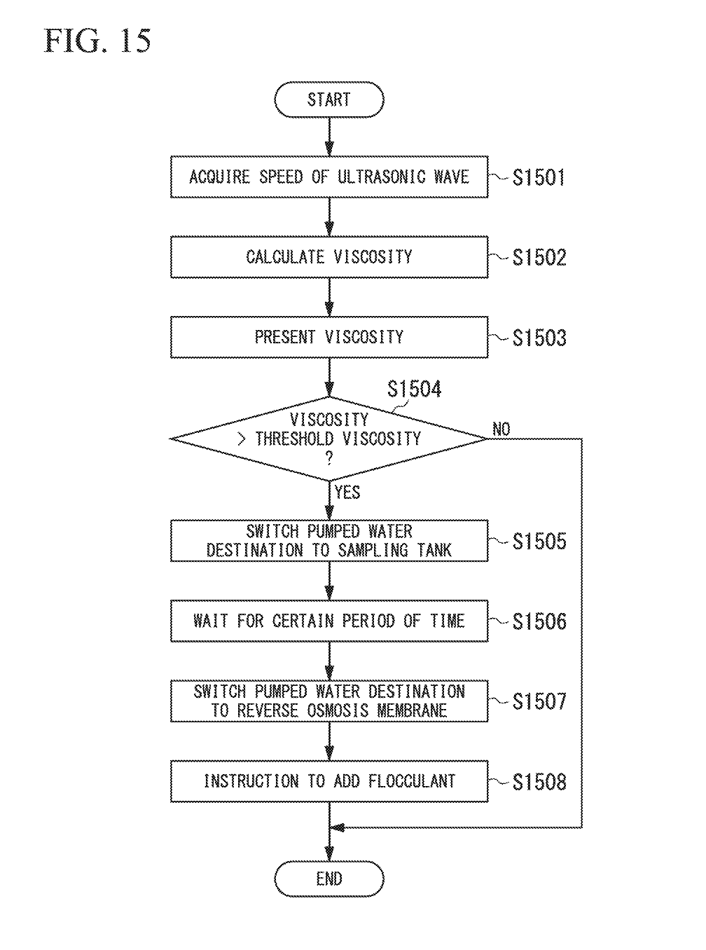

FIG. 15 is a flowchart showing a sequence of a water quality monitoring process according to the sixth embodiment.

The water quality monitoring device 111 performs the following water quality monitoring process at regular intervals. When the water quality monitoring device 111 starts the water quality monitoring process, the speed determination unit 301 acquires information indicating the speed of an ultrasonic wave from the measurement device 108 (step S1501). The viscosity calculation unit 302 then calculates the viscosity of water that is supplied to the reverse osmosis membrane 109 on the basis of the information acquired by the speed determination unit 301 (step S1502). The presentation unit 303 then allows the display device to display the viscosity calculated by the viscosity calculation unit 302 (step S1503).

The evaluation unit 304 evaluates whether or not the viscosity calculated by the viscosity calculation unit 302 is greater than the predetermined threshold viscosity (step S1504). When the viscosity of water is equal to or less than the predetermined threshold viscosity (step S1504: NO), the water quality monitoring device 111 terminates the water quality monitoring process and waits until the time of execution of a next water quality monitoring process. On the other hand, when the viscosity of water is greater than the predetermined threshold viscosity (step S1504: YES), the sampling processing unit 1401 switches the opening and closing of the three-way valve 1302 such that the water pumped by the second pump 107 is delivered to the sample tank 1301 (step S1505). The sampling processing unit 1401 waits until a predetermined amount of water is stored in the sample tank 1301 (step S1506). Upon finishing the waiting, the sampling processing unit 1401 switches the opening and closing of the three-way valve 1302 such that the water pumped by the second pump 107 is delivered to the reverse osmosis membrane 109 (step S1507).

The concentration reduction processing unit 305 then outputs a command to add a flocculant to the chemical injection device 105 (step S1508). The water quality monitoring device 111 then terminates the water quality monitoring process and waits until the time of execution of a next water quality monitoring process.

According to the present embodiment, when the quality of the water supplied to the reverse osmosis membrane 109 has been reduced, the water quality monitoring device 111 can sample the water as described above. This allows the manager of the seawater treatment system 1 to analyze the quality of the sampled water. That is, the water quality monitoring device 111 according to the present embodiment can contribute to determining the causative substances of fouling through water quality analysis.

Although the embodiments have been described in detail with reference to the drawings, the specific configurations are not limited to those described above and various design changes or the like can be made.

In the embodiments described above, the water quality monitoring device 111 evaluates whether or not to perform a process of reducing the concentration of organic matter in water present upstream of the reverse osmosis membrane 109, but the present invention is not limited to this. For example, in another embodiment, the manager of the seawater treatment system 1 may perform the same processes as that of the above-described embodiments by viewing parameters correlated with the concentration of organic matter presented by the presentation unit 303. Examples of parameters correlated with the concentration of organic matter are warnings indicating that the viscosity of water, the speed of an ultrasound wave, the estimated concentration of organic matter, and the volume fraction of organic matter are high. In this case, the water quality monitoring device 111 may include at least the speed determination unit 301 and the presentation unit 303. On the other hand, in another embodiment, the water quality monitoring device 111 may not include the presentation unit 303 when the water quality monitoring device 111 performs a process of reducing the concentration of organic matter in water present upstream of the reverse osmosis membrane 109.

Although the speed determination unit 301 according to the above embodiments acquires information indicating the speed from the measurement device 108, the present invention is not limited to this and the speed determination unit 301 may acquire another physical quantity related to the speed. For example, in another embodiment, the speed determination unit 301 may acquire information indicating the viscosity from the measurement device 108 when the viscosity is calculated based on the speed of an ultrasonic wave measured by the measurement device 108. For example, the speed determination unit 301 according to another embodiment may acquire, from the measurement device 108, information indicating a period of time from when an ultrasonic wave is transmitted to when the ultrasonic wave is received.

Although the density determination unit 901 according to the above embodiments acquires information indicating the density from the measurement device 108, the present invention is not limited to this and the density determination unit 901 may acquire another physical quantity related to the density. For example, the density determination unit 901 according to another embodiment may acquire the resonant frequency of the U-shaped tube 203 from the measurement device 108.

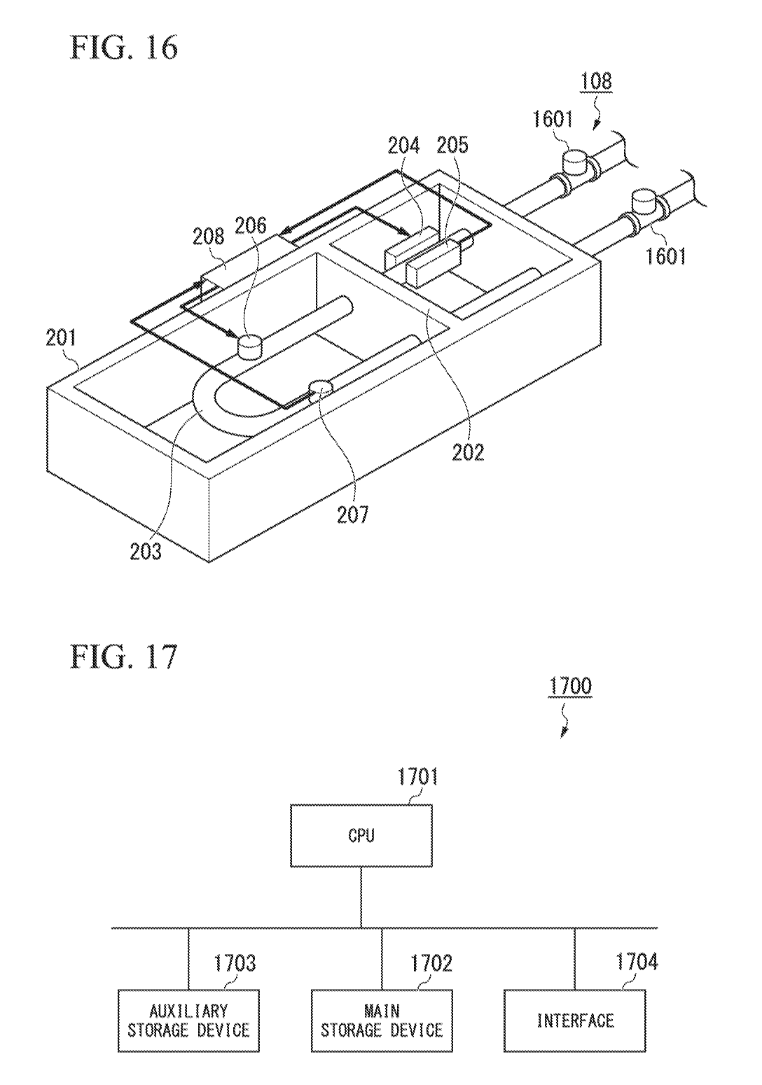

FIG. 16 is a cross-sectional view showing a structure of a measurement device according to a modified example.

Both ends of the U-shaped tube 203 of the measurement device 108 according to the above-described embodiments are attached directly to the pipe connecting the second pump 107 and the reverse osmosis membrane 109, but the present invention is not limited to this. For example, in other embodiments, one or both ends of the U-shaped tube 203 may be attached to the pipe via a valve 1601 as shown in FIG. 16. Thus, while the calculator 208 measures the period of time from when an ultrasonic wave is transmitted to when the ultrasonic wave is received, it is possible to stop the flow of water in the U-shaped tube 203 during measurement by closing the valve 1601.

FIG. 17 is a schematic block diagram showing a configuration of a computer according to at least one of the embodiments.

The computer 1700 includes a CPU 1701, a main storage device 1702, an auxiliary storage device 1703, and an interface 1704.

The water quality monitoring device 111 described above is mounted on the computer 1700. The operations of the processing units described above are stored in the auxiliary storage device 1703 in the form of a program. The CPU 1701 reads the program from the auxiliary storage device 1703, develops the program in the main storage device 1702, and executes the above processes according to the program.

In at least one of the embodiments, the auxiliary storage device 1703 is an example of a non-transitory tangible medium. Other examples of a non-transitory tangible medium include a magnetic disk, a magneto-optical disk, a CD-ROM, a DVD-ROM, or a semiconductor memory connected via the interface 1704. Further, when this program is delivered to the computer 1700 via a communication line, the computer 1700 may develop the program in the main storage device 1702 upon receiving the program and execute the above processes.

The program may be one for realizing some of the functions described above. The program may also be a so-called differential file (differential program) which realizes the functions described above in combination with a program which has already been recorded m the auxiliary storage device 1703.

### INDUSTRIAL APPLICABILITY

The water quality monitoring device 111 measures the speed of a wave generated in water present upstream of the reverse osmosis membrane 109. Therefore, using a computer capable of processing at an appropriate temporal resolution, the water quality monitoring device 111 can detect changes in concentration of fouling substances at several hundred ppb.

### REFERENCE SIGNS LIST

1 Seawater treatment system
108 Measurement device
109 Reverse osmosis membrane
111 Water quality monitoring device
204 Ultrasonic wave transmitter
205 Ultrasonic wave receiver
206 Oscillator
207 Vibration detector
301 Speed determination unit
302 Viscosity calculation unit
303 Presentation unit
304 Evaluation unit
305 Concentration reduction processing unit
901 Density determination unit
1101 Volume fraction calculation unit
1401 Sampling processing unit

1-17. (canceled)

18. A water quality monitoring device which monitors water quality in a water treatment device generating fresh water using a reverse osmosis membrane, the water quality monitoring device comprising:
a speed determination unit configured to determine a speed of a wave passing through water present upstream of the reverse osmosis membrane to measure a parameter correlated with a concentration of organic matter in the water;
a density determination unit configured to determine a density of water present upstream of the reverse osmosis membrane; and
a concentration reduction processing unit configured to reduce the concentration of organic matter in water present upstream of the reverse osmosis membrane when the speed determined by the speed determination unit is greater than a predetermined threshold speed and the density determined by the density determination unit is less than a predetermined threshold density.

19. The water quality monitoring device according to claim 18, wherein the concentration reduction processing unit reduces the concentration of organic matter in water present upstream of the reverse osmosis membrane by using a method corresponding to a speed range that includes the speed determined by the speed determination unit, the speed range being one of a plurality of speed ranges, the method being different for each speed range.

20. The water quality monitoring device according to claim 18, wherein the concentration reduction processing unit reduces the concentration of organic matter in water present upstream of the reverse osmosis membrane by outputting a command to add a flocculant to a chemical injection device, the chemical injection device adding a flocculant to water that is supplied to a pretreatment device provided upstream of the reverse osmosis membrane.

21. The water quality monitoring device according to claim 18, wherein the concentration reduction processing unit reduces the concentration of organic matter in water present upstream of the reverse osmosis membrane by activating a backwash device, the backwash device backwashing a pretreatment device provided upstream of the reverse osmosis membrane.

22. The water quality monitoring device according to claim 18, further comprising:
a concentration determination unit configured to determine a parameter correlated with a concentration of organic matter and a parameter correlated with a concentration of inorganic microparticles on the basis of the speed determined by the speed determination unit and the density determined by the density determination unit,
wherein the concentration reduction processing unit reduces the concentration of organic matter in water present upstream of the reverse osmosis membrane when the parameter correlated with the concentration of organic matter determined by the concentration determination unit is greater than the predetermined threshold speed; and
the concentration reduction processing unit reduces the concentration of inorganic matter in water present upstream of the reverse osmosis membrane when the parameter correlated with the concentration of inorganic matter determined by the concentration determination unit is greater than the predetermined threshold speed.

23. A water quality monitoring device which monitors water quality in a water treatment device generating fresh water using a reverse osmosis membrane, the water quality monitoring device comprising:
a speed determination unit configured to determine a speed of a wave passing through water present upstream of the reverse osmosis membrane to measure a parameter correlated with a concentration of organic matter in the water;
a density determination unit configured to determine a density of water present upstream of the reverse osmosis membrane;
a concentration determination unit configured to determine a parameter correlated with a concentration of organic matter and a parameter correlated with a concentration of inorganic microparticles on the basis of the speed determined by the speed determination unit and the density determined by the density determination unit; and
a presentation unit configured to present the parameter correlated with the concentration of organic matter and the parameter correlated with the concentration of inorganic microparticles.

24. The water quality monitoring device according to claim 18, further comprising:
a storage processing unit configured to store part of water present upstream of the reverse osmosis membrane in a predetermined container when the speed determined by the speed determination unit is greater than the predetermined threshold speed.

25. The water quality monitoring device according to claim 18, wherein the speed determination unit determines a speed of a wave passing through water before passing through a pretreatment device and a speed of a wave passing through water after passing through the pretreatment device, the pretreatment device being provided upstream of the reverse osmosis membrane.

26. A water treatment device comprising:
a reverse osmosis membrane;
a vibration tube through that water present upstream of the reverse osmosis membrane flows;
an oscillator configured to vibrate the vibration tube;
a vibration detector configured to detect a vibrational amplitude of the vibration tube,
a wave transmitter provided on the vibration tube and configured to generate a wave in water present upstream of the reverse osmosis membrane; and
a wave receiver provided on the vibration tube and configured to detect the wave generated by the wave transmitter.

27. A water treatment system comprising:
the water treatment device according to claim 26; and
a water quality monitoring device comprising:
a speed determination unit configured to determine a speed of a wave passing through water present upstream of the reverse osmosis membrane to measure a parameter correlated with a concentration of organic matter in the water;
a density determination unit configured to determine a density of water present upstream of the reverse osmosis membrane; and
a concentration reduction processing unit configured to reduce the concentration of organic matter in water present upstream of the reverse osmosis membrane when the speed determined by the speed determination unit is greater than a predetermined threshold speed and the density determined by the density determination unit is less than a predetermined threshold density.

28. A water quality monitoring method comprising the steps of:
determining a speed of a wave passing through water present upstream of a reverse osmosis membrane;
determining a density of water present upstream of the reverse osmosis membrane; and
reducing the concentration of organic matter in water present upstream of the reverse osmosis membrane when the determined speed is greater than a predetermined threshold speed and the determined density is less than a predetermined threshold density.

29. A program causing a computer for a water quality monitoring device, which monitors water quality in a water treatment device that generates fresh water using a reverse osmosis membrane, stored in a non-transitory computer readable recording medium, to function as:
a speed determination unit configured to determine a speed of a wave passing through water present upstream of the reverse osmosis membrane to measure a parameter correlated with a concentration of organic matter in the water;
a density determination unit configured to determine a density of water present upstream of the reverse osmosis membrane; and
a concentration reduction processing unit configured to reduce the concentration of organic matter in water present upstream of the reverse osmosis membrane when the speed determined by the speed determination unit is greater than a predetermined threshold speed and the density determined by the density determination unit is less than a predetermined threshold density.

30. A program causing a computer for a water quality monitoring device, which monitors water quality in a water treatment device that generates fresh water using a reverse osmosis membrane, stored in a non-transitory computer readable recording medium, to function as:
a speed determination unit configured to determine a speed of a wave passing through water present upstream of the reverse osmosis membrane to measure a parameter correlated with a concentration of organic matter in the water;
a density determination unit configured to determine a density of water present upstream of the reverse osmosis membrane;
a concentration determination unit configured to determine a parameter correlated with a concentration of organic matter and a parameter correlated with a concentration of inorganic microparticles on the basis of the speed determined by the speed determination unit and the density determined by the density determination unit; and
a presentation unit configured to present the parameter correlated with the concentration of organic matter and the parameter correlated with the concentration of inorganic microparticles.
